(19) United States
(12) Patent Application Publication
(10) Pub. No.: US 2025/0065678 A1
(43) Pub. Date: Feb. 27, 2025

(54) TIRE ORIENTATION AND PRESSURE ADJUSTMENT TO BALANCE TRACTION AND RANGE

(71) Applicant: Polestar Performance AB, Göteborg (SE)

(72) Inventors: Hans PEHRSON, Torslanda (SE); Olof NORBERG, Göteborg (SE)

(73) Assignee: Polestar Performance AB, Göteborg (SE)

(21) Appl. No.: 18/725,008

(22) PCT Filed: Dec. 28, 2022
(86) PCT No.: PCT/EP2022/087957

§ 371 Date: Jun. 27, 2024

Related U.S. Application Data
(60) Provisional application No. 63/266,080, filed on Dec. 28, 2021.

(51) Int. Cl. B60C 23/10; B60C 19/00; B62D 17/00

(52) U.S. Cl. CPC B60C 23/10; B62D 17/00; B60C 2019/004

(57) ABSTRACT

Active tire orientation and pressure adjustment systems and methods of use in response to a plurality of activation conditions can ensure efficient tire orientation and pressure modes are active when necessary to balance tire traction and driving range of an electric vehicle. The activation conditions can be customized based on driver preferences to help ease range anxiety while providing a balance with vehicle traction.

### TECHNICAL FIELD

Embodiments relate generally to active tire orientation and pressure adjustment to balance tire traction and driving range, and more particularly to automatic tire orientation and pressure adjustment to balance tire traction and driving range of electric vehicles based on user preferences and energy considerations.

### BACKGROUND

Some drivers experience range anxiety when using electric vehicles. Range anxiety can be defined as the fear that a vehicle battery has insufficient charge to reach its destination or a suitable charging point, thus leaving the occupants stranded along the road. Range anxiety can be considered a major barrier to the wide scale adoption of electric vehicles that are solely powered by batteries. Range anxiety is particularly a problem for drivers of electric vehicles due to the shorter range of electric vehicles compared to gas-fueled cars, fewer charging stations than gas stations, and long charging times. To help ease these concerns, systems and methods are needed that can extend the driving range of electric vehicles.

Tire orientation and pressure are known to affect various driving characteristics including driving range and handling performance of the vehicle. The primary mechanism by which tire orientation and pressure affect these driving characteristics is tire traction. Traction is a complex concept that is partially defined by the coefficient of static friction between the tire and the ground, partially by the surface area of the contact between the tire and the ground, and partially by the tread pattern of the vehicle. On different terrain, different aspects may predominate. For example, on sand or gravel, the surface area of contact or the tread pattern may be relatively more important. Generally, a tire can be designed with either high traction or low rolling resistance, but not both. That is, low traction coincides with an improvement in driving range because of reduced friction and thus a reduction in the amount of energy required to propel the vehicle forward. Conversely, handling performance is generally highest when the friction and grip between the ground and the vehicle, or the surface area between the tire and the ground, is maximized. An example of the latter type of tire is a so-called “winter tire.”

For drivers of electric vehicles, there is a desire to maintain a balance between driving range and tire traction to lessen the concern of range anxiety while providing a level of handling performance that ensures a smooth and comfortable driving experience. This balance has traditionally been achieved by using low rolling-resistance tires for daily driving, and switching these for winter tires or racing tires when necessary for a particular driving environment or purpose.

There have been attempts to incorporate active adjustment of either tire orientation or tire pressure to optimize a vehicle's driving characteristics. For example, U.S. Pat. No. 10,053,148 discloses a system for actively altering a tire's orientation to optimize vehicle agility and stability. Another example is described in U.S. Pat. No. 9,522,577 which discloses a tire pressure system that actively alters a tire's pressure in response to various vehicle conditions. Another example is described in U.S. Pub. Pat. App. No. 2018/0251156 which discloses a tire orientation system that actively alters a tire's camber angle relative to the vehicle's frame. However, these references do not relate to specific considerations for electric vehicles.

### SUMMARY

Embodiments of the present disclosure provide for systems, methods, and kits related to active tire orientation and pressure adjustment of an electric vehicle to balance driving range and tire traction. In embodiments, systems and methods allow for seamless transition between tire orientation and pressure modes in response to various activation conditions. This seamless transition helps to maintain a balance between driving range and tire traction to lessen the concern of range anxiety while providing a level of handling performance that ensures a smooth and comfortable driving experience. In embodiments, kits comprise various components for use with active tire orientation and pressure adjustment systems. The components of these kits may be used as replacement parts for existing active tire orientation and pressure adjustment systems, or for use during installation of new active tire orientation and pressure adjustment systems onto existing electric vehicles.

Active tire orientation and pressure adjustment systems of an electric vehicle can comprise a vehicle control unit, a tire orientation unit, a tire pressure unit, a user interface, and a communication interface. The vehicle control unit can be configured to receive vehicle and navigational data via the user interface and the communication interface. The vehicle control unit can then process the vehicle and navigational data to determine if an activation condition is present. If an activation condition is present, the vehicle control unit can communicate the activation condition and relevant data to the tire orientation unit and the tire pressure unit which can then change the current tire orientation and pressure mode, if necessary. Activation conditions can represent a plurality of circumstances for which operating active tire orientation and pressure adjustment systems is advantageous. Among other things, the user interface and the communication interface can be configured to provide occupants of the electric vehicle with alerts when certain activation conditions have been met. The user interface can be further configured to receive input commands from a user or occupant of the electric vehicle. The communication interface can be further configured to provide wireless communication between a user device and/or a network, and the electric vehicle.

Active tire orientation and pressure adjustment methods can comprise steps related to detecting an activation condition, determining if the electric vehicle is operating in an energy efficient tire orientation and pressure mode, and alerting an electric vehicle driver of the activation condition. Other active tire orientation and pressure adjustment methods can comprise steps related to using one or both of the tire orientation unit and the tire pressure unit to actively adjust tire orientation and pressure based on the presence of one or more activation conditions.

Active tire orientation and pressure adjustment kits can comprise the vehicle control unit, the tire orientation unit, and the tire pressure unit, each having various constituent components as detailed in the present disclosure.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a first active tire orientation and pressure adjustment system for use with an electric vehicle, according to embodiments.

FIG. 2 is a block diagram of a second active tire orientation and pressure adjustment system for use with an electric vehicle, according to embodiments.

FIG. 3 is a top simplified schematic view of an electric vehicle equipped with a first active tire orientation and pressure adjustment system, according to embodiments.

FIG. 4 is a top simplified schematic view of an electric vehicle equipped with a second active tire orientation and pressure adjustment system, according to embodiments.

FIG. 5 is a simplified schematic top view of an electric vehicle operating in a toe-in tire orientation with a positive toe angle α, according to embodiments.

FIG. 6 is a simplified schematic top view of an electric vehicle operating in a toe-out tire orientation with a negative toe angle α, according to embodiments.

FIG. 7 is a side view of a tire of an electric vehicle equipped with various components from both a tire orientation unit and a tire pressure unit, according to embodiments.

FIG. 8 is a front view of a tire of an electric vehicle operating in a neutral camber tire orientation, according to embodiments.

FIG. 9 is a front view of a tire of an electric vehicle operating in a negative camber tire orientation with a negative camber angle β, according to embodiments.

FIG. 10 is a front view of a tire of an electric vehicle operating in a positive camber tire orientation with a positive camber angle β, according to embodiments.

FIG. 11A is a flow chart of a method for automatic operation of active tire orientation and adjustment systems based on activation conditions, according to embodiments.

FIG. 11B is a flow chart of a method for actively adjusting tire orientation of an electric vehicle in response to the presence of an activation condition, according to embodiments.

FIG. 11C is a flow chart of a first method for actively adjusting tire pressure of an electric vehicle in response to the presence of an activation condition, according to embodiments.

FIG. 11D is a flow chart of a second method for actively adjusting tire pressure of an electric vehicle in response to the presence of an activation condition, according to embodiments.

FIG. 11E is a flow chart of a first method for actively and simultaneously adjusting tire orientation and pressure of an electric vehicle in response to the presence of an activation condition, according to embodiments.

FIG. 11F is a flow chart of a second method for actively and simultaneously adjusting tire orientation and pressure of an electric vehicle in response to the presence of an activation condition, according to embodiments.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

As described above, there has conventionally been a tradeoff between rolling resistance and traction. Tire traction is so closely related to the resistance between the tire and the ground that tires are generally categorized as being low rolling resistance, or high traction, but not both. Some drivers will attempt to hybridize these by, for example, reducing the pressure in a low rolling-resistance tire such that the surface area between the tire and the ground increases slightly, therefore increasing traction at a cost of efficiency.

Generally, then, a driver who wants to increase the range of their vehicle will have to accept lower tire traction. Conversely, a driver who wants high handling performance (that is, high grip and traction) will have to accept lower vehicle range, due to the reduced driving efficiency. Depending on various considerations including the type of roadway, roadway conditions, driver preferences, and navigational concerns (e.g., location of fueling stations, distance to destination), this may or may not be acceptable.

In fact, not all traction is created equal. As described in more detail below, some types of tire orientations (e.g., toe-in) are more effective for stopping a vehicle, while other types of tire orientations (referred to as toe-out) are more effective for starting from a stop. Still other types of tire orientations (such as camber adjustment) are useful to increase traction while cornering. Finally, tire pressure is a useful tool for responding to changes in road conditions or driving surface composition. Combinations of toe, camber, and tire pressure, especially when used selectively on two or even four tires, can be used to accomplish a desired balance between rolling resistance and traction that provides performance on demand, while also enhancing vehicle range.

It may be advantageous to use a particular tire orientation and pressure mode of operation to optimize a vehicle's driving characteristics and provide a balance between tire traction and driving range. As described herein, autonomous adjustments to tire orientation and pressure can effectively respond to these considerations and allow the vehicle to operate using an optimal tire orientation and pressure mode in response to the immediate circumstances of the vehicle and/or preferences of the driver. Active tire orientation and pressure adjustment is one way to provide drivers with the ability to balance tire traction and driving range as well as to reduce range anxiety associated with electric vehicles. Previous attempts fail to address efficiency considerations of an electric vehicle, for which recharging may take significantly longer than refueling an internal combustion engine, but in which electronics and sensors are relatively abundant and easy to use compared to internal combustion vehicles.

As described herein, a solution is provided in which battery level and driving range are used to actively adjust orientation or pressure of a tire in response to various conditions. Those conditions can include battery charge level, terrain, navigational information, real-time weather information, and driver behavior.

As described herein, active tire orientation and pressure adjustment systems, methods, and kits are presented that facilitate increased driving ranges based on energy considerations of electric vehicles. The active tire orientation and pressure adjustment systems of the present disclosure provide for automatic adjustment of both tire orientation and pressure in response to a plurality of activation conditions including but not limited to distance to nearest charging station, battery level dipping below a threshold, changes in road surface conditions, changes in road direction (e.g., curvatures, right-angle turns), operational state of vehicle, time of day, and weather conditions (e.g., rain, snow, temperature, wind speed, atmospheric air pressure). Other activation conditions, including those added as preferences by the driver and/or vehicle occupant, are also applicable with the active tire orientation and pressure adjustment systems of the present disclosure.

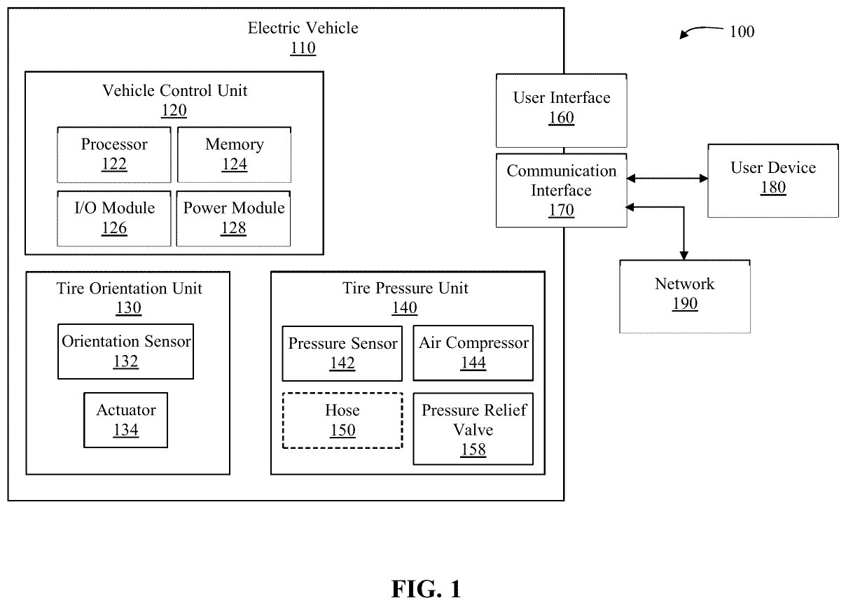

FIG. 1 is a block diagram of a first active tire orientation and adjustment system 100 (First system 100) for actively adjusting tire orientation and pressure during operation of an electric vehicle 110, according to embodiments. First system 100 generally comprises vehicle control unit 120, tire orientation unit 130, tire pressure unit 140, user interface 160, and communication interface 170. Vehicle control unit 120 can be configured to receive vehicle and navigational data via user interface 160 and communication interface 170. Vehicle control unit 120 can then process the vehicle and navigational data to determine if an activation condition is present. Activation conditions represent a plurality of circumstances when using first system 100 is advantageous. If an activation condition is present, vehicle control unit 120 communicates the activation condition and relevant data to tire orientation unit 130 and tire pressure unit 140. Activation conditions of particular relevance to the present disclosure relate to balancing the driving range against the traction of electric vehicle 110 by using first system 100, and thereby entering an energy efficient tire orientation and pressure mode, when appropriate. Navigational data and battery level of electric vehicle 110 can be used to help determine activation conditions of first system 100, such that energy efficiency can be balanced with user preferences and/or vehicle traction. First system 100 represents an improvement over conventional operation of systems for adjusting tire orientation and pressure that fail to address efficiency considerations of an electric vehicle such as battery level and driving range and are incapable of actively adjusting both tire orientation and pressure simultaneously in response to various activation conditions, much less coordinating all of these adjustments to improve overall performance and range of an electric vehicle.

Vehicle control unit 120 is configured to process data relevant to operation of electric vehicle 110, including but not limited to data pertaining to the vehicle condition, the environment of the vehicle, and navigational data, and to communicate the processed data to a plurality of vehicle engines comprising vehicle subsystems (e.g., steering subsystems, braking subsystems, navigation subsystems, communication subsystems, and the like). Vehicle control unit 120 can comprise processor 122, memory 124, input/output (I/O) module 126, and power module 128, according to embodiments.

Though not shown in FIG. 1, it should be understood that in embodiments vehicle control unit 120 can also include any of a plurality of sensors. Such sensors can include, for example, any of the sensors used in a traction control system, which could indicate an increased need for traction. Such sensors could also include, for example, those sensors used in a safety system such as semi self-driving sensors, which could indicate an imminent increased need for stopping force, or sensors to detect a green light ahead that could indicate an imminent increased need for starting force. Other sensors could include, for example, ice, snow, or rain sensors, or sensors that indicate an upcoming corner or curve.

Processor 122 can include fixed function circuitry and/or programmable processing circuitry. Processor 122 can include any one or more of a microprocessor, a controller, a digital signal processor (DSP), an application-specific integrated circuit (ASIC), a field-programmable gate array (FPGA), or equivalent discrete or analog logic circuitry. In some examples, processor 122 can include multiple components, such as any combination of one or more microprocessors, one or more controllers, one or more DSPs, one or more ASICs, or one or more FPGAs, as well as other discrete or integrated logic circuitry. The functions attributed to processor 122 herein may be embodied as software, firmware, hardware, or any combination thereof.

Memory 124 can include computer-readable instructions that, when executed by processor 122, cause vehicle control unit 120 to perform various functions. Memory 124 can include volatile, non-volatile, magnetic, optical, or electrical media, such as a random-access memory (RAM), read-only memory (ROM), non-volatile RAM (NVRAM), electrically-erasable programmable ROM (EEPROM), flash memory, or any other digital media.

I/O module 126 can support user interfaces and communication systems enabling communication with computing devices, components of first system 100, and other vehicle systems. Computing devices can include devices that are associated with the vehicle or a vehicle occupant. In embodiments, a computing device can be a mobile device, including a cellphone, a laptop, a tablet computer, or other type of computing device that is not permanently connected to the vehicle. Communication systems can comprise wired or wireless network interface devices and the like. I/O module 126 can be communicatively coupled to the communication interface 170 within the vehicle. Additionally, I/O module 126 can be communicatively coupled to at least one user interface within the vehicle, including user interface 160. The at least one user interface can be configured to receive user input through touch input, one or more user interface buttons, voice commands, or other known means of receiving user input. Such modules are often integrated in electric vehicles (and others) already.

Power module 128 can comprise any type of power source, including a car battery. One or more components of power module 128 can control the power source or change the characteristics of the power provided to the various systems and subsystems of the vehicle. In embodiments, power module 128 can be powered by a conventional car battery (e.g., at 12V) or from the main battery of an electric vehicle (e.g., 200-800V) having been transformed to an appropriate voltage.

Tire orientation unit 130 is configured to work in conjunction with vehicle control unit 120 and can comprise orientation sensor 132 and actuator 134. It should be understood that the tire orientation unit 130 can be duplicated for each tire that is controlled. Therefore for a sedan or coupe there may be four tire orientation units 130, or for other vehicles there could be two, three, or even a large number (such as eighteen) of sensors each independently sensing and actuating a respective tire.

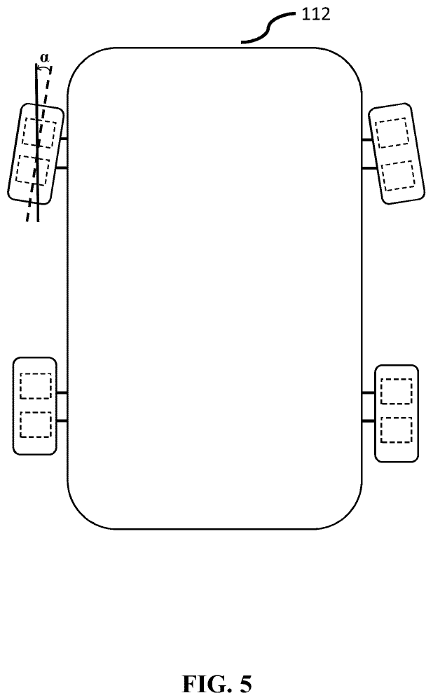

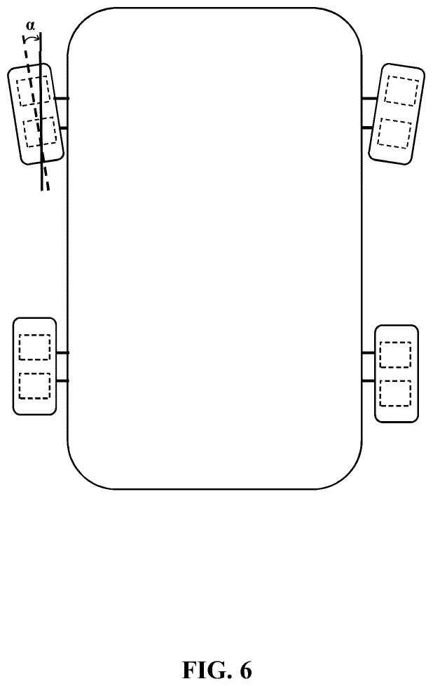

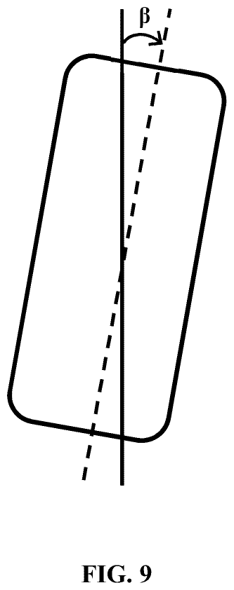

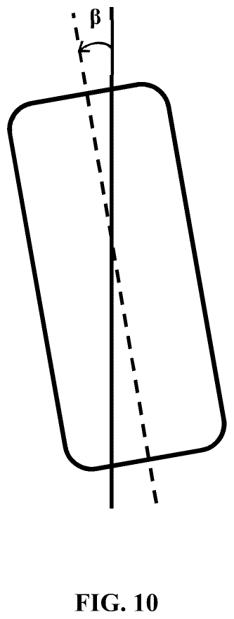

Orientation sensor 132 is generally fixedly coupled to each tire 116 of electric vehicle 110 and communicatively coupled to vehicle control unit 120. Orientation sensor 132 is configured to actively measure toe angle α (FIGS. 5, 6) and camber angle β (FIGS. 9, 10) while electric vehicle 110 is in operation. Orientation sensor 132 is further configured to send toe angle α and camber angle β data to vehicle control unit 120 where said data is processed and formed into one or more instructions that are sent from vehicle control unit 120 to tire orientation unit 130. In embodiments, one or more other orientation sensors may be fixedly coupled to each tire 116, including but not limited to a yaw sensor, a caster angle sensor, and an anti-slip sensor. In embodiments, orientation sensor 132 may be further configured to actively measure yaw, caster angle, and anti-slip data, and to send said data to vehicle control unit 120.

Actuator 134 is generally fixedly coupled each tire 116 of electric vehicle 110 and communicatively coupled to vehicle control unit 120. Actuator 134 may be operated in one of many ways including hydraulically, pneumatically, or electrically, according to embodiments. Actuator 134 is configured to activate and adjust toe angle α and camber angle β in response to a set of instructions received from the vehicle control unit 120. Based on activation conditions, user preferences, and current tire orientation mode, actuator 134 may adjust only toe angle α, only camber angle β, both toe angle α and camber angle β, or neither toe angle α nor camber angle β.

Tire pressure unit 140 is configured to work in conjunction with vehicle control unit 120 and can comprise pressure sensor 142, air compressor 144, hose 150 (optional), and pressure relief valve 158, according to embodiments of first system 100. Like tire orientation unit 130, in some embodiments there may be a separate tire pressure unit 140 corresponding to each tire that is controlled.

Pressure sensor 142 is generally fixedly coupled to each tire 116 of electric vehicle 110 and communicatively coupled to vehicle control unit 120. Pressure sensor 142 is configured to actively measure air pressure of tire 116 while electric vehicle 110 is in operation. Pressure sensor 142 is further configured to send air pressure data to vehicle control unit 120 where said data is processed and formed into one or more instructions that are sent from vehicle control unit 120 to tire pressure unit 140.

Air compressor 144 generally includes at least one air outlet 146 and at least one air inlet 148. Air outlet 146 facilitates the flow of pressurized air out of air compressor 144 and directly to the tire, or alternatively to the tire through at least one hose 150. Air inlet 148 facilitates the flow of standard air into air compressor 144 where the standard air is then pressurized. In embodiments, a single air compressor 144 having multiple air outlets 146 is provided to supply pressurized air to each tire 116 of electric vehicle 110. In embodiments, more than one air compressor 144 is provided to supply pressurized air, including a single air compressor 144 supplied to each tire 116 of electric vehicle 110.

Hose 150 generally includes an elongated tube member 152 having a first end 154 and a second end 156. First end 154 is generally securely coupled to air outlet 146 of air compressor 144, while second end 156 is generally securely coupled to a valve stem 159 attached to each tire 116 of electric vehicle 110. In embodiments, first end 154 and second end 156 may be swapped such that first end 154 is securely coupled to valve stem 159 and second end 156 is securely coupled to air outlet 146. In embodiments, hose 150 is used in conjunction with one or more branching devices 157 to facilitate the flow of pressurized air through a single air outlet 146. In embodiments, a plurality of hoses 150 each being securely coupled to a plurality of air outlets 146 are used to facilitate the flow of pressurized air to each tire 116 of electric vehicle 110 simultaneously.

Pressure relief valve 158 is generally securely coupled to each tire 116 and communicatively coupled to vehicle control unit 120. Pressure relief valve 158 generally works in conjunction with air compressor 144 during operation of tire pressure unit 140, according to embodiments of first system 100. The function of pressure relief valve 158 is to relieve tire 116 of excess air pressure in order to achieve an optimal pressure mode. Pressure relief valve 158 is configured to activate in response to a set of instructions received from the vehicle control unit 120.

Tire orientation unit 130 and tire pressure unit 140 can be configured to actively and simultaneously adjust either one or both of tire orientation and tire pressure when activation conditions are present. Settings and user preferences of first system 100 can be received via user interface 160 and communication interface 170.

In embodiments, electric vehicle 110 is configured to wirelessly communicate with user device 180 and network 190 via communication interface 170. Network 190 can be in communication with a server, such as a cloud-based server, that can include a memory and at least one data processor. In addition, the server can collect and retrieve data from one or more external sources, such as a variety of navigational services, in some embodiments. The one or more external sources can assist the server with providing first system 100 with information characterizing the driving range of electric vehicle 110 in real-time. In embodiments, the one or more external sources can collect a variety of data from electric vehicle 110 that can include one or more of a battery charge consumption, condition of battery, vehicle location, weather or road conditions along an expected route, car component usage, and the like.

First system 100 can be configured to automatically operate tire orientation unit 130 and tire pressure unit 140 of electric vehicle 110 based on experienced activation conditions. In embodiments, first system 100 can be customizable based on user preferences such that settings of tire orientation unit 130 and tire pressure unit 140 as well as activation conditions can be modified. A user can input commands via user interface 160, or via user device 180 such as through an app on a smartphone. In embodiments, the user can turn off or choose to manually control tire orientation unit 130 and tire pressure unit 140. In embodiments, user interface 160 and communication interface 170 can provide occupants of electric vehicle 110 with alerts when certain activation conditions have been met, such as battery level dipping below a threshold. Additionally, users can provide input in some embodiments regarding desired driving mode, such as a desire to be in a high-traction, high-performance mode or a high-range, power-efficient mode.

First system 100 represents an improvement over conventional active tire orientation and pressure systems that fail to leverage the energy conserving benefits that result from active adjustment of both orientation and pressure of a tire simultaneously. As a practical matter, traction is highly important for performance driving, but is not needed during a significant portion of the drive time for a typical vehicle, such as when driving on straightaways on dry pavement. Low rolling resistance can significantly increase the range of an electric vehicle, but decreases performance and traction at key moments and reduces the performance of the vehicle during stopping, starting, cornering, and driving on difficult terrain such as ice, loose material, or wet or oily surfaces. Navigational data and battery level can be used to help determine activation conditions of first system 100, such that energy efficiency can be balanced with user preferences in a manner that is not addressed by operation of conventional systems. Additionally, first system 100 can ease range anxiety of occupants by continually monitoring battery level and navigational considerations, such as distance to the nearest charging station, and providing alerts when activation conditions are met. Thus, first system 100 provides automated operation of tire orientation unit 130 and tire pressure unit 140 that conveniently extends the driving range of electric vehicle 110.

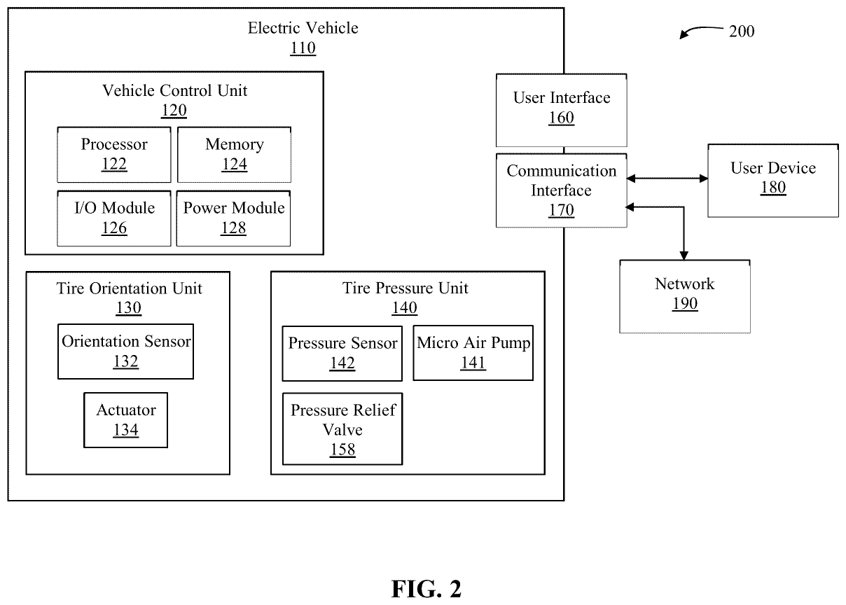

FIG. 2 is a block diagram of a second active tire orientation and pressure adjustment system 200 (second system 200) for actively adjusting tire orientation and pressure during operation of an electric vehicle 110, according to embodiments. Second system 200 generally comprises vehicle control unit 120, tire orientation unit 130, tire pressure unit 140, user interface 160, and communication interface 170. Several aspects of second system 200 are functionally identical to first system 100 and incorporate each improvement and benefit attributed to first system 100 as was detailed in the preceding paragraphs. Additionally, second system 200 is structurally identical to first system 100 for the features having identical reference numbers thereto, and incorporates each component attributed to first system 100 in the preceding paragraphs, with an exception being that of the constituent components of the tire pressure unit 140. Instead of using air compressor 144 and hose 150 to supply pressurized air to each tire 116, as was done using the first system 100, a micro air pump 141 attached to each tire 116 is used. Micro air pump 141 is configured to generate pressurized air and supply said pressurized air directly to tire 116 without needing air compressor 144 and hose 150. Micro air pump 141 generally works in conjunction with pressure relief valve 158 during operation of tire pressure unit 140, according to embodiments of second system 200. Micro air pump 141 is generally fixedly coupled to tire 116 and communicatively coupled to vehicle control unit 120. Micro air pump 141 is further configured to receive a set of instructions from vehicle control unit 120 and activate in response to said set of instructions. Activation may occur due to the micro air pump 141 operating in a low-energy or idling mode when not actively in use. In embodiments of second system 200, micro air pump 141 is continuously active and thus does not need to be separately activated.

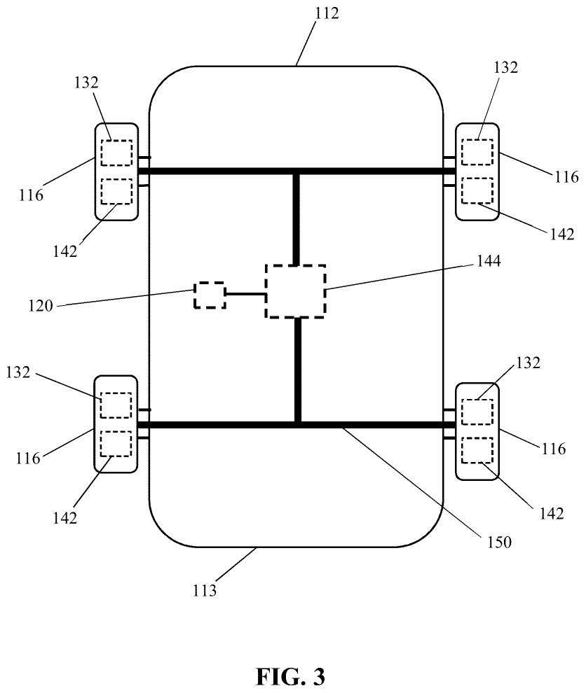

FIG. 3 is a top view of an electric vehicle 110 equipped with a first system (like 100 described above) and operating with a neutral toe tire orientation, according to embodiments. Neutral toe tire orientation is defined as tire 116 having a substantially non-existent toe angle α (FIGS. 5, 6) with respect to a longitudinal axis of tire 116 and thus being directed substantially parallel to a direction of travel by electric vehicle 110. In that respect, FIG. 3 shows an ideal orientation of tires for driving on a straight, dry, paved surface when no sudden stops or starts are anticipated. The orientation shown in FIG. 3 will have relatively low rolling resistance, though in neutral toe and camber positions there is reduced traction for cornering, starting, and stopping.

Each tire 116 of electric vehicle 110 is equipped with at least orientation sensor 132, pressure sensor 142, and actuator 134, such that orientation sensor 132 can actively measure toe angle α and camber angle β, pressure sensor 142 can actively measure air pressure of tire 116, and actuator 134 can actively adjust toe angle α and camber angle β based on instructions from vehicle control unit 120.

In embodiments of first system 100, air compressor 144 and vehicle control unit 120 are positioned in a central area of a frame 114 of electric vehicle 110 such that the distance between front end 112 and air compressor 144 and vehicle control unit 120 is approximately equivalent to the distance between rear end 113 and air compressor 144 and vehicle control unit 120. In embodiments of first system 100, air compressor 144 and vehicle control unit 120 are positioned substantially closer to front end 112 than rear end 113. In embodiments of first system 100, air compressor 144 and vehicle control unit 120 are positioned substantially closer to rear end 113 than front end 112.

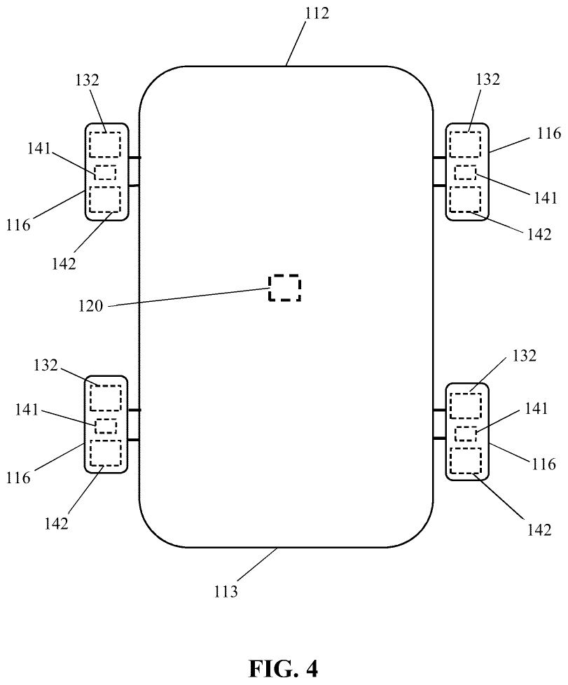

FIG. 4 is a top view of an electric vehicle 110 equipped with a second system (e.g., second system 200 described above) and operating with a neutral toe tire orientation, according to embodiments. The second system eliminates the need for air compressor 144 and hose 150, and hence comprises a single micro air pump 141 fixedly coupled to each tire 116 instead. Although vehicle control unit 120 is shown disconnected from the remaining components of the system, it should be understood that wired or wireless connections can be made between such systems as needed. Alternatively, vehicle control unit 120 could be replaced in embodiments by individual processors at each tire communicating with other sensors, memory, or processors to independently operate its corresponding tire.

FIG. 5 is a top view of an electric vehicle 110 operating in a front-wheel toe-in tire orientation, according to embodiments. The direction of travel of the vehicle shown in FIG. 5 should be understood to be towards the top of the page. Toe-in tire orientation is defined as tire 116 having a positive toe angle α with respect to the longitudinal axis of tire 116 and thus being directed substantially inward toward electric vehicle 110. When operating in a toe-in tire orientation, toe angle α of tire 116 can have any value within the range of +0.1 degrees to +10 degrees with respect to the longitudinal axis of tire 116. During braking of electric vehicle 110, it is generally preferred for each tire 116 located at front end 112 to operate using a toe-in tire orientation to allow for increased stability.

FIG. 6 is a top view of an electric vehicle 110 operating in a front-wheel toe-out tire orientation, according to embodiments. Toe-out tire orientation is defined as tire 116 having a negative toe angle α with respect to the longitudinal axis of tire 116 and thus being directed substantially outward from electric vehicle 110. When operating in a toe-out tire orientation, toe angle α of tire 116 can vary between −0.1 degrees to −10 degrees with respect to the longitudinal axis of tire 116. During initial acceleration of electric vehicle 110, it is generally preferred for each tire 116 that is powered to operate using a toe-out tire orientation to allow for increased performance.

In embodiments, each tire 116 of electric vehicle 110 operates using the same tire orientation mode. In embodiments, tires 116 located at the front end 112 operate using a different tire orientation mode than the tires 116 located at the rear end 113. In embodiments, each tire 116 of electric vehicle 110 operates using a unique tire orientation mode each having a unique toe angle α.

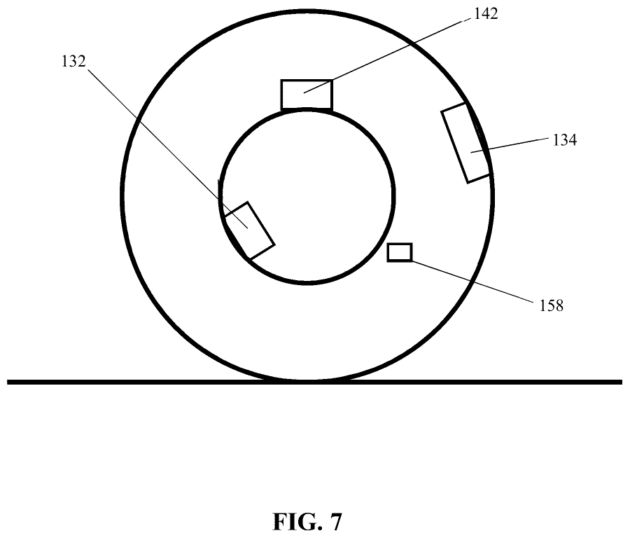

FIG. 7 is a side view of a tire 116 of an electric vehicle 110 equipped with orientation sensor 132, pressure sensor 142, pressure relief valve 158, and actuator 134, according to embodiments. Orientation sensor 132, pressure sensor 142, pressure relief valve 158, and actuator 134 are each generally fixedly coupled to tire 116. Actuator 134 is generally configured to adjust toe angle α and camber angle β based on a set of instructions received from the vehicle control unit 120. In embodiments, some features (such as pressure sensing and relief valve) can be combined into single structures.

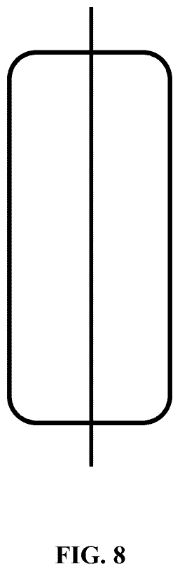

FIG. 8 is a front view of a tire 116 of an electric vehicle 110 operating in a neutral camber tire orientation, according to embodiments. Neutral camber tire orientation is defined as tire 116 having a non-existent camber angle β with respect to a transverse axis of tire 116 and thus being directed substantially perpendicular to the direction of travel by electric vehicle 110.

FIG. 9 is a front view of a tire 116 of an electric vehicle 110 operating in a negative camber tire orientation, according to embodiments. Negative camber tire orientation is defined as tire 116 having a negative camber angle β with respect to a transverse axis of tire 116 and thus being directed substantially inward toward electric vehicle 110. When operating in a negative camber tire orientation, camber angle β of tire 116 can have any value within the range of −0.1 degrees to −10 degrees with respect to the transverse axis of tire 116.

Camber, as described above, can be helpful to increase cornering traction. However, operating in a positive camber orientation over the long term can be damaging to the tire and make the ride less comfortable. Running a vehicle with non-zero camber also generally decreases efficiency and increases rolling resistance. Therefore systems like those described above can be used to increase camber during periods of time when cornering is needed, either based on driver input through the steering wheel, or via navigational data such as route guidance through switchbacks, or by activation of a performance mode when driving more aggressively through corners (such as on an oval track), or combinations thereof.

FIG. 10 is a side view of a tire 116 of an electric vehicle 110 operating in a positive camber tire orientation with a positive camber angle β, according to embodiments. Positive camber tire orientation is defined as tire 116 having a positive camber angle β with respect to a transverse axis of tire 116 and thus being directed substantially outward from electric vehicle 110. When operating in a positive camber tire orientation, camber angle β of tire 116 can have any value within the range of +0.1 degrees to +10 degrees with respect to the transverse axis of tire 116.

It should be understood that camber can be adjusted for several or all of the tires of a vehicle based on the above-described inputs. Generally speaking positive camber is better for vehicle stability, while negative camber is common in high performance vehicles that require better cornering, and zero camber is best for range. Therefore different inputs could prompt the vehicle control unit 120 to put the vehicle into any of these states based on the driver's needs and driving conditions.

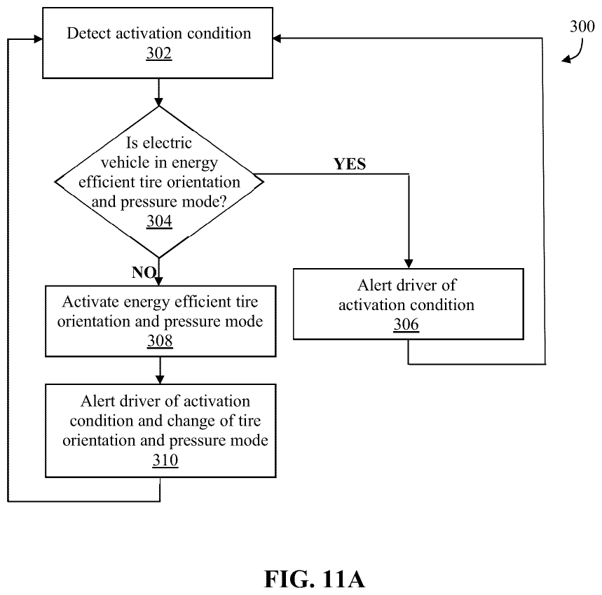

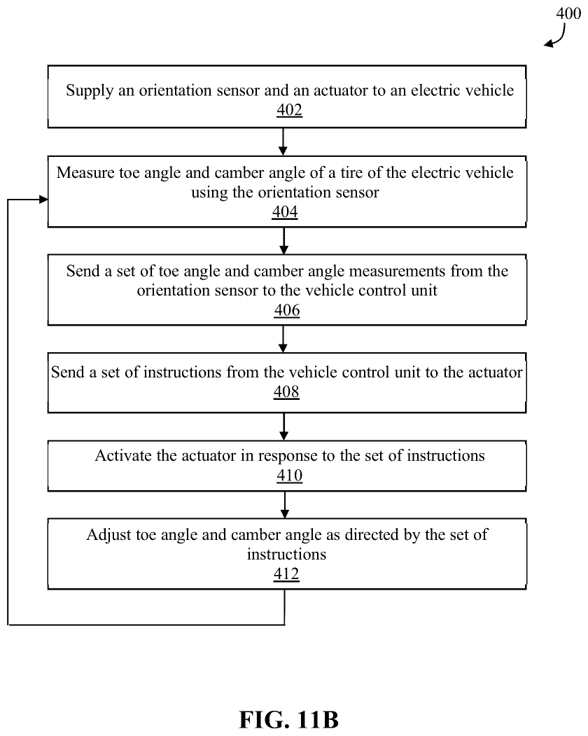

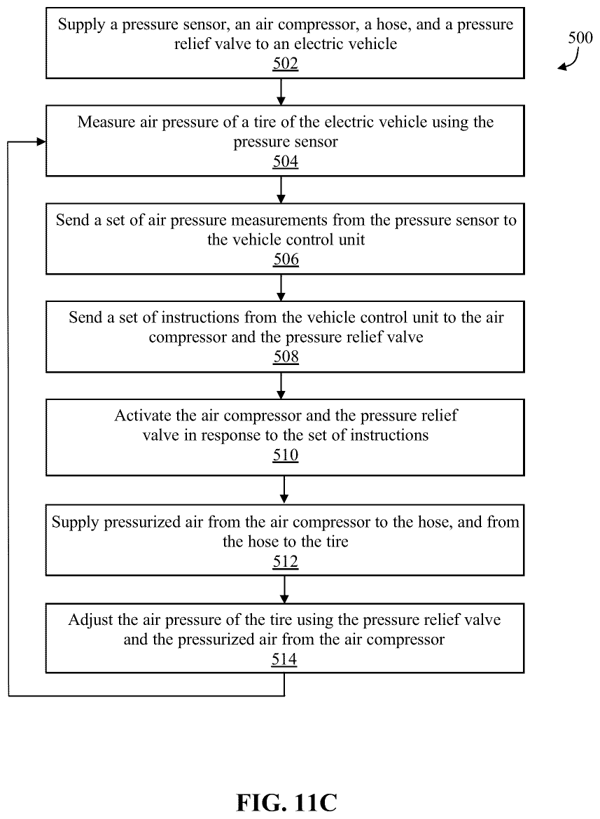

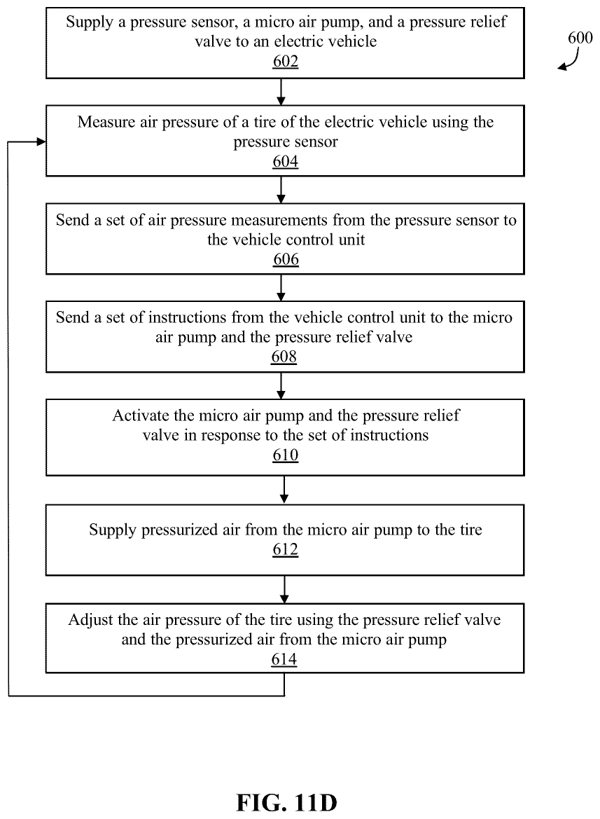

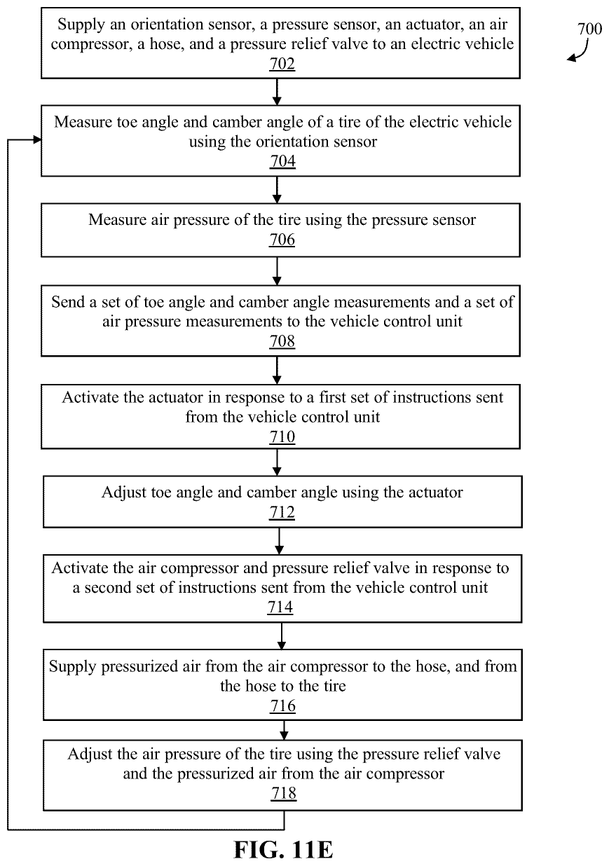

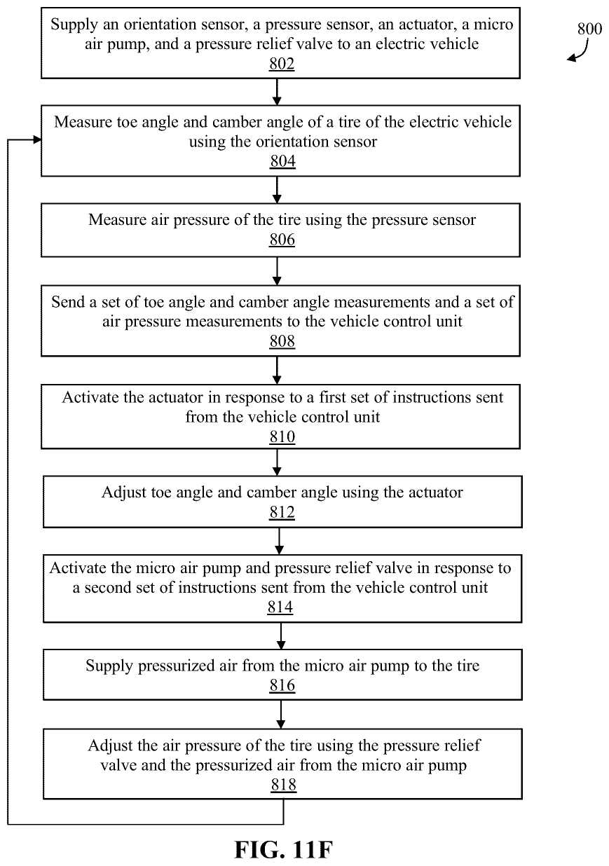

FIG. 11A depicts a flowchart of a method 300 for initiating a change in tire orientation and pressure mode based on an activation condition. In embodiments, method 300 can be used with first system 100 or second system 200. At step 302, an activation condition is detected. Exemplary activation conditions include but are not limited to current battery level passing a threshold, the determined range of the electric vehicle, navigational considerations (e.g., location of charging stations, distance to destination), and the like. At step 304, the tire orientation and pressure mode of the vehicle is checked to determine if an energy efficient tire orientation and pressure mode is active. If an energy efficient tire orientation and pressure mode is already active, an alert of the activation condition can be provided to the driver in step 306. If the vehicle is not currently in an energy efficient tire orientation and pressure mode, an energy efficient tire orientation and pressure mode is activated in step 308. At step 310, an alert of the activation condition and change of tire orientation and pressure mode is provided to the driver. In embodiments, the driver can be prompted to confirm activation of the energy efficient tire orientation and pressure mode before the energy efficient tire orientation and pressure mode is activated. In embodiments, alerts can be provided to the driver via user interface 160 or communication interface 170.

In embodiments, an activation condition justifying a change in tire orientation and pressure mode can be a battery level threshold. In such embodiments, method 300 can occur when the battery level of electric vehicle 110 passes a threshold. In embodiments, the battery level threshold can be 25% of the total charge of the battery. In embodiments, the battery level threshold can be set by a user. At step 304, the tire orientation and pressure mode of electric vehicle 110 is checked to determine if an energy efficient tire orientation and pressure mode is active. If an energy efficient tire orientation and pressure mode is already active, an alert of the current battery level can be provided to the driver. If electric vehicle 110 is not currently in an energy efficient tire orientation and pressure mode, an energy efficient tire orientation and pressure mode can be activated. In embodiments, if the battery is charged such that the battery level surpasses the battery level threshold, both first system 100 and second system 200 can automatically switch from an energy efficient tire orientation and pressure mode to a different tire orientation and pressure mode.

FIG. 11B depicts a flow chart of a method 400 for actively adjusting tire orientation in response to the presence of an activation condition. In embodiments, method 400 can be used with first system 100 or second system 200. At step 402, an orientation sensor 132 and an actuator 134 are supplied to an electric vehicle 110. Orientation sensor 132 is configured to actively measure toe angle α and camber angle β of tire 116. Actuator 134 is configured to received one or more instructions from a vehicle control unit 120 and actively adjust toe angle α and camber angle β in response to the one or more instructions. At step 404, one or more values of each of toe angle α and camber angle β of tire 116 are measured using the orientation sensor 132. At step 406, orientation sensor 132 sends a set of toe angle α and camber angle β measurements to the vehicle control unit 120. The transmission of the set of toe angle α and camber angle β measurements may occur wirelessly or along a wired connection between the orientation sensor 132 and the vehicle control unit 120. At step 408, the vehicle control unit 120 sends a set of instructions to the actuator 134. The set of instructions may comprise machine-readable data which directs the actuator to respond in one of many ways including adjusting toe angle α, adjusting camber angle β, adjusting toe angle α and camber angle β, or adjusting neither toe angle α nor camber angle β. At step 410, the actuator 134 is activated in response to the set of instructions received from the vehicle control unit 120. Activation may occur due to the actuator 134 operating in a low-energy or idling mode when not actively in use. In embodiments, the actuator 134 is continuously active and thus does not need to be separately activated as in step 410. At step 412, the actuator 134 adjusts one or both or neither of toe angle α and camber angle β in response to the set of instructions received from the vehicle control unit 120.

FIG. 11C depicts a flow chart of a method 500 for actively adjusting tire pressure in response to the presence of an activation condition. In embodiments, method 500 is used with first system 100. At step 502, a pressure sensor 142, an air compressor 144, a hose 150, and a pressure relief valve 158 are supplied to an electric vehicle 110. Pressure sensor 142 is configured to actively measure air pressure of tire 116. Air compressor 144 and hose 150 are configured to generate and facilitate, respectively, the flow of pressurized air into tire 116. Pressure relief valve 158 is configured to relieve tire 116 of excess air pressure. At step 504, one or more air pressure values of tire 116 are measured using the pressure sensor 142. At step 506, pressure sensor 142 sends a set of air pressure measurements to the vehicle control unit. The transmission of the set of air pressure measurements may occur wirelessly or along a wired connection between the pressure sensor 142 and the vehicle control unit 120. At step 508, the vehicle control unit 120 sends a set of instructions to the air compressor 144 and the pressure relief valve 158. The set of instructions may comprise machine-readable data which directs the air compressor to supply pressurized air to tire 116. At step 510, the air compressor 144 and the pressure relief valve 158 are activated in response to the set of instructions received from the vehicle control unit 120. Activation may occur due to the air compressor 144 operating in a low-energy or idling mode when not actively in use. In embodiments, air compressor 144 is continuously active and thus does not need to be separately activated as in step 510. At step 512, the air compressor 144 supplies pressurized air to tire 116 through one or more hoses 150. In embodiments, branching device 157 may be used to facilitate the flow of pressurized air out of air compressor 144 through a single hose 150 which then branches off into one or more other hoses 150. At step 514, air pressure of tire 116 is adjusted using pressurized air from the air compressor 144 and the pressure relief valve 158 until achieving an optimal pressure mode. In embodiments, one or both of air compressor 144 and pressure relief valve 158 do not activate according to step 510 in response to the set of instructions received from the vehicle control unit 120.

FIG. 11D depicts a flow chart of a method 600 for adjusting tire pressure in response to the presence of an activation condition. In embodiments, method 600 is used with second system 200. At step 602, a pressure sensor 142, a micro air pump 141, and a pressure relief valve 158 are supplied to an electric vehicle 110. Micro air pump 141 is configured to generate pressurized air and supply said pressurized air directly to tire 116 of electric vehicle 110. At step 604, one or more air pressure values of tire 116 are measured using the pressure sensor 142. At step 606, pressure sensor 142 sends a set of air pressure measurements to the vehicle control unit 120. At step 608, the vehicle control unit 120 sends a set of instructions to the micro air pump 141 and the pressure relief valve 158. At step 610, the micro air pump 141 and the pressure relief valve 158 are activated in response to the set of instructions received from the vehicle control unit 120. Activation may occur due to the micro air pump 141 operating in a low-energy or idling mode when not actively in use. In embodiments, micro air pump 141 is continuously active and thus does not need to be separately activated as in step 610. At step 612, micro air pump 141 supplies pressurized air directly to tire 116. At step 614, air pressure of tire 116 is adjusted using pressurized air from the micro air pump 141 and the pressure relief valve 158 until achieving an optimal pressure mode. In embodiments, one or both of micro air pump 141 and pressure relief valve 158 do not activate according to step 610 in response to the set of instructions received from the vehicle control unit 120.

FIG. 11E depicts a flow chart of a method 700 for actively and simultaneously adjusting tire orientation and pressure due to the presence of an activation condition. In embodiments, method 700 is used with first system 100. At step 702, an orientation sensor 132, a pressure sensor 142, an actuator 134, an air compressor 144, a hose 150, and a pressure relief valve 158 are supplied to an electric vehicle 110. At step 704, one or more values of each of toe angle α and camber angle β of a tire 116 are measured using the orientation sensor 132. At step 706, one or more air pressure values of tire 116 are measured using the pressure sensor 142. At step 708, orientation sensor 132 sends a set of toe angle α and camber angle β measurements to the vehicle control unit 120. At step 710, the actuator 134 is activated in response to a first set of instructions received from the vehicle control unit 120. At step 712, the actuator 134 adjusts one or both or neither of toe angle α and camber angle β in response to the first set of instructions received from the vehicle control unit 120. At step 714, the air compressor 144 and the pressure relief valve 158 are activated in response to a second set of instructions received from the vehicle control unit 120. At step 716, the air compressor 144 supplies pressurized air to tire 116 through one or more hoses 150. At step 718, air pressure of tire 116 is adjusted using pressurized air from the air compressor 144 and the pressure relief valve 158 until achieving an optimal pressure mode. In embodiments, one or both of air compressor 144 and pressure relief valve 158 do not activate according to step 714 in response to the second set of instructions received from the vehicle control unit 120. In embodiments, actuator 134 does not activate according to step 710 in response to the first set of instructions received from the vehicle control unit. In embodiments, the order of steps 704 through 718 may be altered such that, for example, the steps of adjusting air pressure using tire pressure unit 140 occur before the steps of adjusting orientation using tire orientation unit 130.

FIG. 11F depicts a flow chart of a method 800 for actively and simultaneously adjusting tire orientation and pressure due to the presence of an activation condition. In embodiments, method 800 is used with second system 200. At step 802, an orientation sensor 132, a pressure sensor 142, an actuator 134, a micro air pump 141, and a pressure relief valve 158 are supplied to an electric vehicle 110. At step 804, one or more values of each of toe angle α and camber angle β of a tire 116 are measured using the orientation sensor 132. At step 806, one or more air pressure values of tire 116 are measured using the pressure sensor 142. At step 808, orientation sensor 132 sends a set of toe angle α and camber angle β measurements to the vehicle control unit 120. At step 810, the actuator 134 is activated in response to a first set of instructions received from the vehicle control unit 120. At step 812, the actuator 134 adjusts one or both or neither of toe angle α and camber angle β in response to the first set of instructions received from the vehicle control unit 120. At step 814, the micro air pump 141 and the pressure relief valve 158 are activated in response to a second set of instructions received from the vehicle control unit 120. At step 816, micro air pump 141 supplies pressurized air directly to tire 116. At step 818, air pressure of tire 116 is adjusted using pressurized air from the micro air pump 141 and the pressure relief valve 158 until achieving an optimal pressure mode. In embodiments, one or both of micro air pump 141 and pressure relief valve 158 do not activate according to step 814 in response to the second set of instructions received from the vehicle control unit 120. In embodiments, actuator 134 does not activate according to step 810 in response to the first set of instructions received from the vehicle control unit. In embodiments, the order of steps 804 through 818 may be altered such that, for example, the steps of adjusting air pressure using tire pressure unit 140 occur before the steps of adjusting orientation using tire orientation unit 130.

While the flowcharts of FIGS. 11A, 11B, 11C, 11D, 11E, and 11F have been discussed and illustrated in relation to a particular sequence of events, it should be appreciated that changes, additions, and omissions can occur without materially affecting the operation of the disclosed embodiments, methods, configurations, and aspects.

Using data received from network 190, vehicle control unit 120 can be configured to continuously update an estimated driving range in real-time, according to embodiments. The updated estimated driving range information can be provided to a driver of electric vehicle 110 in a variety of ways, such as displaying the information on user interface 160 or user device 180. In embodiments, the estimated driving range can be supplemented with other navigational data, including traffic and weather conditions nearby or along the driving route. In embodiments, an estimated driving range for an inactive tire orientation and pressure mode can be calculated, such that the difference in driving ranges can be displayed to the driver. The driver can then use the displayed driving ranges to make an informed decision on whether to remain in the current tire orientation and pressure mode. In embodiments, the estimated ranges of multiple tire orientation and pressure modes can be presented to the driver after receiving a request to switch tire orientation and pressure modes. In embodiments, statistics of additional distance traveled by electric vehicle 110 because of first system 100 or second system 200 can be tracked and presented to the driver.

In embodiments, a determination that the estimated range of electric vehicle 110 is insufficient to reach a destination can be an activation condition justifying a change in tire orientation and pressure mode. The destination of electric vehicle 110 can be determined based on user input, driving history, or the like. In embodiments, user input can be received from user interface 160 or user device 180 via communication interface 170. In some embodiments, network 190 can be communicatively coupled to a server including a driving history database which can compile past trip data relating to the driving history of electric vehicle 110. In embodiments, the driving history database can be continually updated in real-time. The past trip data can include, for example, locations frequented by electric vehicle 110 and times of past trips. Based on one or more of the past trips data, current driving pattern of electric vehicle 110, and other navigational data, such as expected traffic data, vehicle control unit 120 or the server can estimate a likely destination of the current trip.

Other navigational considerations, such as presence of charging stations nearby, can be used as activation conditions, according to embodiments. The estimated range of electric vehicle 110 can be compared to navigational data that includes the locations of charging stations to determine the number of charging stations within the estimated driving range. If there are limited or no charging stations within the estimated driving range, first system 100 or second system 200 can be automatically switched to an energy efficient tire orientation and pressure mode if one is not already active. In embodiments, if the improvement in driving range from the energy efficient tire orientation and pressure mode is still insufficient to reach a convenient charging station, an alert can be provided to the driver.

In embodiments, type of roadway can serve as an activation condition for changing tire orientation and pressure modes. For example, if the roadway is determined to be a highway, electric vehicle 110 can be automatically switched to an energy efficient tire orientation and pressure mode. Roadway determination can be achieved through sensing means of electric vehicle 110, navigational data, and the like.

In embodiments, first system 100, second system 200, and/or their components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain, or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random-access memory (RAM), dynamic random-access memory (DRAM), or static random-access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In embodiments, the systems or components described herein can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which, while being executed, transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, I/O facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Embodiments of the present disclosure provide a seamless driving experience that leverages automatically swapping between modes of tire orientation and pressure to effectively extend the driving range of an electric vehicle. A plurality of activation conditions can ensure energy efficient tire orientation and pressure modes are active when necessary and can be customized based on driver preferences. The use of activation conditions in conjunction with proactive alerts can ease range anxiety. Thus, embodiments of the present disclosure represent significant advancements over conventional active tire orientation and pressure adjustment systems that do not account for energy efficiency, particularly for electric vehicles.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A system for active tire orientation and pressure adjustment of an electric vehicle, the system comprising:
a vehicle control unit;
a tire orientation unit fixedly coupled to the electric vehicle and communicatively coupled to the vehicle control unit and
configured to actively adjust tire orientation in response to an instruction received from the vehicle control unit

2. The system of claim 1, further comprising a user interface configured to receive a signal from an occupant of the electric vehicle, wherein the instruction is based on the signal.

3. The system of claim 1, further comprising a tire pressure unit fixedly coupled to the electric vehicle and communicatively coupled to the vehicle control unit.

4. The system of claim 1, wherein the vehicle control unit comprises a processor, a memory unit, an input and output module, and a power module.

5. The system of claim 1, wherein the tire orientation unit comprises a plurality of orientation sensors and a plurality of actuators.

6. The system of claim 5, wherein each of the plurality of orientation sensors and the plurality of actuators are fixedly coupled to the electric vehicle.

7. The system of claim 5, wherein the plurality of orientation sensors are configured to actively measure toe angle and camber angle.

8. The system of claim 5, wherein the plurality of actuators are configured to receive the instruction from the vehicle control unit.

9. The system of claim 8, wherein the plurality of actuators are further configured to actively adjust toe angle and camber angle in response to the instruction.

10. The system of claim 3, wherein the tire pressure unit comprises a plurality of pressure sensors, a plurality of micro air pumps, and a plurality of pressure relief valves.

11. The system of claim 10, wherein the plurality of pressure sensors are fixedly coupled to the electric vehicle.

12. The system of claim 11, wherein the plurality of pressure sensors are configured to actively measure tire air pressure.

13. The system of claim 10, wherein the plurality of micro air pumps are fixedly coupled to the electric vehicle and are configured to receive a second instruction from the vehicle control unit.

14. The system of claim 13, wherein the plurality of micro air pumps are further configured to supply pressurized air directly to each tire of the electric vehicle.

15. The system of claim 10, wherein the plurality of pressure relief valves are fixedly coupled to the electric vehicle.

16. The system of claim 15, wherein at least one of the plurality of pressure relief valves activates in response to the second instruction received from the vehicle control unit, thus reducing the air pressure in at least one tire of the electric vehicle.

17. The system of claim 16, wherein at least one of the plurality of pressure relief valves does not activate in response to the one or more instructions received from the vehicle control unit, thus maintaining the air pressure in at least one tire of the electric vehicle.

18. The system of claim 3, wherein the tire pressure unit comprises a plurality of pressure sensors, an air compressor, a plurality of hoses, and a plurality of pressure relief valves.

19. The system of claim 18, wherein the plurality of pressure sensors are fixedly coupled to the electric vehicle.

20. The system of claim 19, wherein the plurality of pressure sensors are configured to actively measure tire air pressure.

21. The system of claim 18, wherein the air compressor is fixedly coupled to a frame of the electric vehicle and is configured to receive the second set of instructions from the vehicle control unit.

22. The system of claim 21, wherein the air compressor is further configured to supply pressurized air through the plurality of hoses to each tire of the electric vehicle.

23. The system of claim 18, wherein the plurality of pressure relief valves are fixedly coupled to the electric vehicle.

24. The system of claim 23, wherein at least one of the plurality of pressure relief valves activates in response to the second instruction received from the vehicle control unit, thus reducing the air pressure in at least one tire of the electric vehicle.

25. The system of claim 24, wherein at least one of the plurality of pressure relief valves does not activate in response to the second instruction, thus maintaining the air pressure in at least one tire of the electric vehicle.

26. A method of operating a system for active tire orientation and pressure adjustment of an electric vehicle, the method comprising the steps of:
detecting the presence of an activation condition;
determining if the vehicle is operating in an energy efficient tire orientation and pressure mode; and
alerting an electric vehicle driver of the activation condition.

27. The method of claim 26, further comprising the step of activating the energy efficient tire orientation and pressure mode before alerting the electric vehicle driver of the activation condition.

28. The method of claim 27, further comprising alerting the electric vehicle driver of the activation of the energy efficient tire orientation and pressure mode after activating the energy efficient tire orientation and pressure mode.

29. The method of claim 28, wherein the step of alerting the electric vehicle driver of the activation of the energy efficient tire orientation and pressure mode occurs simultaneously with the step of alerting the electric vehicle driver of the activation condition.

30. A method of actively adjusting tire orientation of an electric vehicle due to the presence of an activation condition, the method comprising the steps of:
supplying an orientation sensor and an actuator to an electric vehicle;
measuring toe angle and camber angle of a tire of the electric vehicle using the orientation sensor;
sending a set of toe angle and camber angle measurements from the orientation sensor to the vehicle control unit;
sending a set of instructions from the vehicle control unit to the actuator;
activating the actuator in response to the set of instructions; and
adjusting toe angle and camber angle as directed by the set of instructions.

31. A method of actively adjusting tire pressure of an electric vehicle due to the presence of an activation condition, the method comprising the steps of:
supplying a pressure sensor, an air compressor, a hose, and a pressure relief valve to an electric vehicle;
measuring air pressure of a tire of the electric vehicle using the pressure sensor;
sending a set of air pressure measurements from the pressure sensor to the vehicle control unit;
sending a set of instructions from the vehicle control unit to the air compressor and the pressure relief valve;
activating the air compressor and the pressure relief valve in response to the set of instructions;
supplying pressurized air from the air compressor to the hose, and from the hose to the tire; and
adjusting the air pressure of the tire using the pressure relief valve and pressurized air from the air compressor.

32. A method of actively adjusting tire pressure of an electric vehicle due to the presence of an activation condition, the method comprising the steps of:
supplying a pressure sensor, a micro air pump, and a pressure relief valve to an electric vehicle;
measuring air pressure of a tire of the electric vehicle using the pressure sensor;
sending a set of air pressure measurements from the pressure sensor to the vehicle control unit;
sending a set of instructions from the vehicle control unit to the micro air pump and the pressure relief valve;
activating the micro air pump and the pressure relief valve in response to the set of instructions;
supplying pressurized air from the micro air pump to the tire; and
adjusting the air pressure of the tire using the pressure relief valve and pressurized air from the air compressor.

33. A method of actively and simultaneously adjusting tire orientation and pressure of an electric vehicle due to the presence of an activation condition, the method comprising the steps of:
supplying an orientation sensor, a pressure sensor, an actuator, an air compressor, a hose, and a pressure relief valve to an electric vehicle
measuring toe angle and camber angle of a tire of the electric vehicle using the orientation sensor;
measuring air pressure of the tire using the pressure sensor;
sending a set of toe angle and camber angle measurements and a set of air pressure measurements to the vehicle control unit;
activating the actuator in response to a first set of instructions received from the vehicle control unit;
adjusting toe angle and camber angle using the actuator;
activating the air compressor and the pressure relief valve in response to a second set of instructions received from the vehicle control unit;
supplying pressurized air from the air compressor to the hose, and from the hose to the tire; and
adjusting air pressure of the tire using the pressure relief valve and pressurized air.

34. A method of actively and simultaneously adjusting tire orientation and pressure of an electric vehicle due to the presence of an activation condition, the method comprising the steps of:
supplying an orientation sensor, a pressure sensor, an actuator, a micro air pump, and a pressure relief valve to an electric vehicle
measuring toe angle and camber angle of a tire of the electric vehicle using the orientation sensor;
measuring air pressure of the tire using the pressure sensor;
sending a set of toe angle and camber angle measurements and a set of air pressure measurements to the vehicle control unit;
activating the actuator in response to a first set of instructions received from the vehicle control unit;
adjusting toe angle and camber angle using the actuator;
activating the micro air pump and the pressure relief valve in response to a second set of instructions received from the vehicle control unit;
supplying pressurized air from the micro air pump to the tire; and
adjusting air pressure of the tire using the pressure relief valve and pressurized air.

35. A kit for use in actively adjusting tire orientation and pressure in an electric vehicle, the kit comprising:
a vehicle control unit;
a tire orientation unit fixedly coupled to the electric vehicle and communicatively coupled to the vehicle control unit; and
a tire pressure unit fixedly coupled to the electric vehicle and communicatively coupled to the vehicle control unit;
wherein the tire orientation unit is configured to actively adjust tire orientation in response to a first set of instructions received from the vehicle control unit; and
wherein the tire pressure unit is configured to actively adjust tire pressure in response to a second set of instructions received from the vehicle control unit.

36. The kit of claim 35, wherein the vehicle control unit comprises a processor, a memory, an input/output module, and a power module.

37. The kit of claim 35, wherein the tire orientation unit comprises an orientation sensor and an actuator.

38. The kit of claim 35, wherein the tire pressure unit comprises a pressure sensor, an air compressor, a hose, and a pressure relief valve.

39. The kit of claim 35, wherein the tire pressure unit comprises a pressure sensor, a micro air pump, and a pressure relief valve.
